(19) United States
(12) Patent Application Publication
(10) Pub. No.: US 2016/0083987 A1
(43) Pub. Date: Mar. 24, 2016

(54) Decorative Structure For Multi-Shaft Hinge Device, Multi-Shaft Hinge Device, And Foldable Device

(71) Applicant: Lenovo (Beijing) Co., Ltd., Beijing (CN)

(72) Inventor: Xiaosong XIA, Beijing (CN)

(73) Assignee: LENOVO (BEIJING) CO., LTD., Beijing (CN)

(21) Appl. No.: 14/670,899

(22) Filed: Mar. 27, 2015

(30) Foreign Application Priority Data
Sep. 23, 2014 (CN) 201410488213.3

(51) Int. Cl. E05D 3/06; E05D 7/00

(52) U.S. Cl. CPC E05D 3/06; E05D 7/00

(57) ABSTRACT

A decorative structure is provided according to the present application, which includes a plurality of multi-shaft hinges rotatably connecting a first installation plate to a second installation plate, the decorative structure including a plurality of connection shafts, a plurality of decorative blocks including at least one first decorative block sleeved on two adjacent connection shafts of the plurality of connection shafts, and at least one second decorative block sleeved on one outmost connection shaft of the plurality of connection shafts and fixedly connected to one of the first installation plate and the second installation plate. The decorative structure can be used for allowing the multi-shaft to have a complete appearance. A multi-shaft hinge device employing the decorative structure and a foldable device with a multi-shaft hinge device employing the decorative structure are further provided by the present application, and each of them have a complete appearance.

This application claims the benefit of priority to Chinese Patent Application No. 201410488213.3 titled “DECORATIVE STRUCTURE FOR MULTI-SHAFT HINGE DEVICE, MULTI-SHAFT HINGE DEVICE, AND FOLDABLE DEVICE”, filed with the Chinese State Intellectual Property Office on Sep. 23, 2014, the entire disclosure of which is incorporated herein by reference.

### TECHNICAL FIELD

The present application relates to the technical field of mechanical industry, and particularly to a decorative structure for a multi-shaft hinge device, a multi-shaft hinge device, and a foldable device.

### BACKGROUND

With the development of the society, more and more hinge devices have emerged. Currently, a commonly-used hinge for a foldable device is the multi-shaft hinge device, which allows two bodies of the foldable device to rotate relative to each other in a range of 0 degree to 360 degrees.

The multi-shaft hinge device includes multiple installation plates and multiple multi-shaft hinges. Each of the multiple installation plates is provided for being fixedly connected to one body of the foldable device. Each of the multiple multi-shaft hinges includes multiple parallel shafts, and adjacent shafts are connected by a connection part. Several connecting rods are provided on a shaft located on the edge of each of the multiple multi-shaft hinges and are fixedly connected to the multiple installation plate. When the multi-shaft hinge device is assembled, the connecting rods at one side of the multiple multi-shaft hinges are fixed on a first installation plate, and the connecting rods at the other side of the multiple multi-shaft hinges are fixed on a second installation plate.

Since two bodies of the foldable device are generally large, the multiple multi-shaft hinges are arranged at intervals on the first installation plate and the second installation plate in the multi-shaft hinge device, thus a stable and reliable connection of the first body and the second body through the multiple multi-shaft hinges is formed. However, a gap exists between adjacent multi-shaft hinges, thus it is difficult to meet the requirement for the appearance of the foldable device.

Thus, a technical problem to be solved presently by those skilled in the art is to provide a decorative structure which can be used for filling a gap between adjacent multi-shaft hinges in the multi-shaft hinge device, to allow a normal folding of the foldable device through the multi-shaft hinge device with the decorative structure, and meet the requirement of users for the appearance of the foldable device.

### SUMMARY

A decorative structure for a multi-shaft hinge device is provided according to the present application, which includes multiple multi-shaft hinges rotatably connecting a first installation plate to a second installation plate, and the decorative structure includes: multiple connection shafts, multiple decorative blocks including: at least one first decorative block sleeved on two adjacent connection shafts of the multiple connection shafts, and at least one second decorative block sleeved on one outmost connection shaft of the multiple connection shafts and fixedly connected to one of the first installation plate and the second installation plate.

A multi-shaft hinge device is provided according to the present application, which includes: a first installation plate provided for being fixedly connected to a first body of a foldable device, a second installation plate provided for being fixedly connected to a second body of the foldable device, at least one multi-shaft hinge, wherein a connection rod at one side of the multi-shaft hinge is fixedly connected to the first installation plate, and a connection rod at the other side of the multi-shaft hinge is fixedly connected to the second installation plate, a decorative structure including: multiple connection shafts, multiple decorative blocks including: at least one first decorative block sleeved on two adjacent connection shafts of the multiple connection shafts, and at least one second decorative block sleeved on one outmost connection shaft of the multiple connection shafts and fixedly connected to one of the first installation plate and the second installation plate.

A foldable device is provided according to the present application, which includes a first body and a second body, wherein the first body is rotatable about the second body in a predetermined angle range through a hinge device, and the hinge device is a multi-shaft hinge device including a first installation plate provided for being fixedly connected to a first body of a foldable device, a second installation plate provided for being fixedly connected to a second body of the foldable device, at least one multi-shaft hinge, wherein a connection rod at one side of the multi-shaft hinge is fixedly connected to the first installation plate, and a connection rod at the other side of the multi-shaft hinge is fixedly connected to the second installation plate, a decorative structure including: multiple connection shafts, multiple decorative blocks including: at least one first decorative block sleeved on two adjacent connection shafts of the multiple connection shafts, and at least one second decorative block sleeved on one outmost connection shaft of the multiple connection shafts and fixedly connected to one of the first installation plate and the second installation plate.

### BRIEF DESCRIPTION OF THE DRAWINGS

In order to more clearly illustrate the embodiments of the present application or the technical solution in the related technology, drawings referred to describe the embodiments or the related technology will be briefly described hereinafter. Apparently, the drawings in the following description are only a few of embodiments of the present application, and for the person skilled in the art, other drawings may be obtained based on these drawings without any creative efforts.

FIG. 1 is an exploded view of a multi-shaft hinge device according to an embodiment of the present application.

FIG. 2 is a perspective view of the multi-shaft hinge device in FIG. 1.

FIG. 3 is an exploded view of a decorative structure for the multi-shaft hinge device according to the embodiment of the present application.

FIG. 4 is an assembly view of another decorative structure and the multi-shaft hinge according to the embodiment of the present application.

FIG. 5 is an exploded view of the decorative structure and the multi-shaft hinge in FIG. 4.

FIG. 6 is a sectional view of another decorative structure.

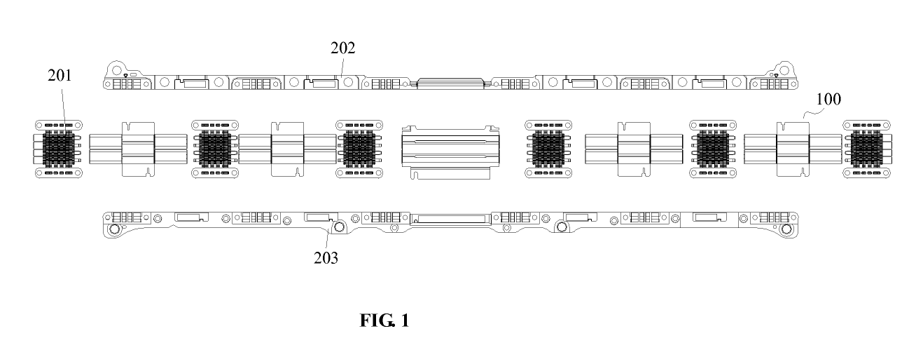

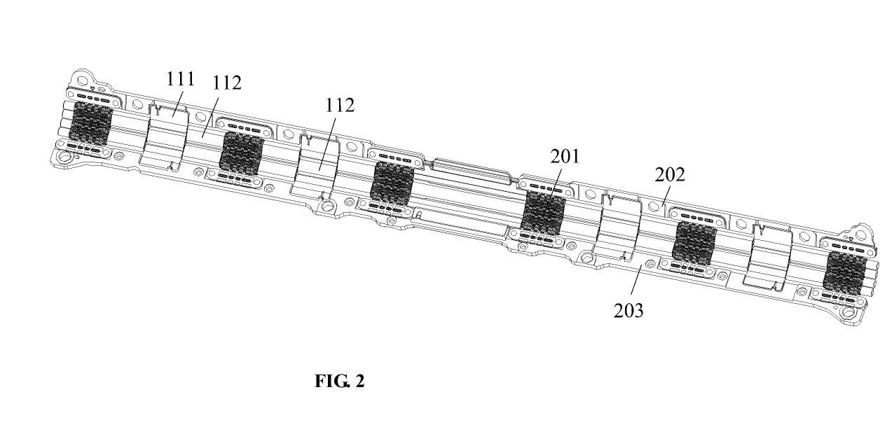

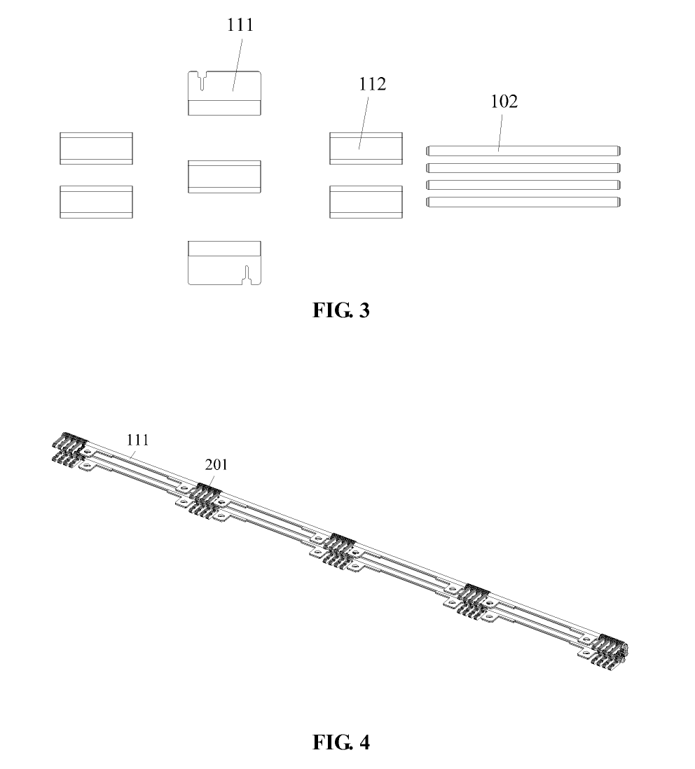

In FIG. 1 to FIG. 6:

| | | | |
|---|---|---|---|
| 100 | decorative structure; | 101 | decorative block; |
| 112 | first decorative block; | 111 | second decorative block; |
| 102 | connection shaft; | 103 | flexible connection body; |
| 201 | multi-shaft hinge; | 202 | first installation plate; |
| 203 | second installation plate. | | |

### DETAILED DESCRIPTION

A decorative structure for a multi-shaft hinge device is provided according to an embodiment of the present application, which may fill up the space between adjacent multi-shaft hinges in the multi-shaft hinge device and avoid a gap in the multi-shaft hinge device, meeting the requirement of users for the appearance of a foldable device. A multi-shaft hinge device is further provided according to the embodiment of the present application, which employs the decorative structure to allow a complete appearance. A foldable device is further provided according to the present application, which employs the multi-shaft hinge device to allow a complete appearance, meeting the requirement of users for the appearance of a foldable device.

The technical solutions in the embodiments of the present application will be described clearly and completely hereinafter in conjunction with the drawings in the embodiments of the present application. Apparently, the described embodiments are only a part of the embodiments of the present application, rather than all embodiments. All of other embodiments, made by the person skilled in the art without any creative efforts based on the embodiments in the present application, fall into the scope of the present application.

Reference is made to FIG. 1 to FIG. 6. A decorative structure 100 for a multi-shaft hinge device is provided according to an embodiment of the present application. The multi-shaft hinge device includes a first installation plate 202, a second installation plate 203, and multiple multi-shaft hinges 201 fixedly connected to the first installation plate 202 and the second installation plate 203. The multiple multi-shaft hinges 201 enable the first installation plate 202 to be rotated about the second installation plate 203 in a predetermined angle range. The decorative structure 100 is arranged between two adjacent multi-shaft hinges 201 in the multi-shaft hinge device. The decorative structure 100 includes a set of connection shafts and multiple decorative blocks 101. The set of connection shafts includes multiple connection shafts 102, and the multiple connection shafts 102 are arranged in parallel. Each of the decorative blocks 101 includes a first decorative block 112 and a second decorative block 111. The first decorative block 112 is provided for being sleeved on the two adjacent connection shafts 102. The second decorative block 111 is provided for being sleeved on outmost connection shafts 102 in the set of connection shafts, in this way, each of the outmost connection shafts 102 may be fixedly connected to the first installation plate 202 or the second installation plate 203.

According to the embodiment of the present application, the first installation plate 202 can freely rotate about the second installation plate 203 in a predetermined angle range, that is, the decorative structure 100 does not affect the articulating function of the multi-shaft hinge device of the decorative structure. Also, the decorative structure 100 is arranged between two adjacent multi-shaft hinges 201 in the multi-shaft hinge device for filling a gap between two adjacent multi-shaft hinges 201. The gap between the adjacent multi-shaft hinges 201 in the multi-shaft hinge device is avoided, meeting the requirement for the appearance of the foldable device which employs the multi-shaft hinge device.

In the decorative structure 100, the number of the connection shafts 102 is same with the number of shafts of each of the multiple multi-shaft hinges 201. In the decorative structure 100, each of the connection shafts 102 is configured to coincide with an axis of a corresponding shaft of each of the multiple multi-shaft hinges 201, that is, in the multi-shaft hinge device employing the decorative structure 100, each shaft in each of the multiple multi-shaft hinges 201 coincides with the axis of the corresponding shaft of the connection shafts 102.

In the decorative structure 100 according to the embodiment of the present application, the number of the connection shafts 102 is same with the number of the shafts of each of the multiple multi-shaft hinges 201, further, each of the connection shafts 102 coincides with the axis of the corresponding shaft of each of the multiple multi-shaft hinges 201, such that the decorative structure 100 can always be substantially flush with each of the multiple multi-shaft hinges 201 in the extension directions of the first installation plate 202 and the second installation plate 203 in the process of the first installation plate 202 rotating about the second installation plate 203 in the multi-shaft hinge device. Thus, the multi-shaft hinge device employing the decorative structure 100 can always keep a complete appearance.

For forming a compact structure, the multiple decorative blocks 101 in the decorative structure 100 are arranged in the direction of the arrangement of the connection shafts 102, and form a set of decorative blocks. The set of decorative blocks includes a first decorative block 112 for connecting two adjacent connection shafts 102. In the set of decorative blocks, two adjacent decorative blocks 101 are sleeved on different connection shafts 102.

Further, in the decorative structure 100, the set of decorative blocks enables each of connection shafts 102 to be sleeved by the decorative blocks 101. In the decorative structure 100 according to the embodiment, the decorative blocks 101 are arranged tightly, and allow a complete appearance, which further allows the entire decorative structure 100 to have a complete appearance and meets the requirement of users for the appearance of the multi-shaft hinge device.

In the decorative structure 100 according to the embodiment of the present application, multiple sets of the decorative blocks are provided, and each set of the decorative blocks is arranged in the direction of the arrangement of the connection shafts 102.

In the decorative structure 100 according to the embodiment of the present application, the first decorative block 112 is staggered in the adjacent sets of decorative blocks, that is, in the two adjacent sets of decorative blocks, two first decorative blocks 112 sleeved on one connection shaft 102 are further sleeved on two connection shafts 102 on both sides of the connection shaft 102, respectively. In the decorative structure 100 according to the embodiment of the present application, the first decorative blocks 112 in the two adjacent sets of decorative blocks are staggered, which allows the two adjacent sets of decorative blocks to not only include a second decorative block 111 fixedly connected to the first installation plate 202, but also include a second decorative block 111 fixedly connected to the second installation plate 202, which further allows a stable and reliable connection of the entire decorative structure 100 and the first installation plate 202, the second installation plate 203.

In the decorative structure 100 according to the embodiment of the present application, the number of the connection shafts 102 in the set of the connection shafts may be an even number. Correspondingly, the set of decorative blocks includes a first set of decorative blocks and a second set of decorative blocks. The first set of decorative blocks only includes the first decorative block 112. The second set of decorative blocks includes the first decorative block 112 and the second decorative block 111 fixedly connected to the first installation plate 202 and the second installation plate 203.

In deed, in the decorative structure 100 according to the embodiment of the present application, the number of the connection shafts 102 in the set of the connection shafts may also be an odd number. Correspondingly, each of the plurality of sets of decorative blocks has a same number of the first decorative blocks 112, and each of the plurality of sets of decorative blocks has a same number of the second decorative blocks 111, and each of the plurality of sets of decorative blocks has one second decorative block 111. In the decorative structure 100, the second decorative blocks 111 in the two adjacent sets of decorative blocks are fixedly connected to the first installation plate 202 and the second installation plate 203, respectively.

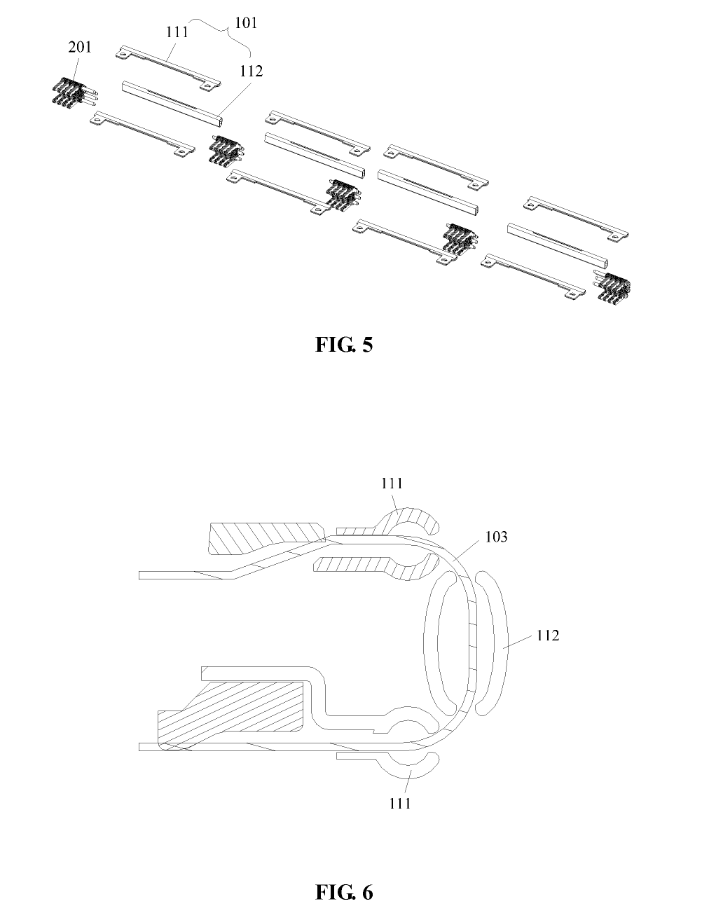

When the number of the connection shafts 102 in the set of connection shafts is an even number, one set of decorative blocks is provided, and the set of decorative blocks includes a first decorative block 112, and two second decorative blocks 111 fixedly connected to the first installation plate 202 and the second installation plate 203, respectively. In the decorative structure 100, since each of the connection shafts 102 is configured to coincide with an axis of a corresponding shaft of the multi-shaft hinge in decorative structure 100, each of the connection shafts 102 may be configured as a shaft of a multi-shaft hinge for reducing the number of components. When being assembled, each shaft of each of the multiple multi-shaft hinges is correspondingly inserted into a corresponding mounting hole at an end of one of the decorative blocks 101, as shown in FIG. 4 and FIG. 5. Further, in the decorative structure 100, a flexible connection body 103 passing through each of decorative blocks 101 may further be provided for filling the gap between two adjacent decorative blocks 101, as shown in FIG. 6.

A multi-shaft hinge device is further provided according to the present application, which includes a first installation plate 202, a second installation plate 203, at least one multi-shaft hinge 201, and a decorative structure 100. The first installation plate 202 is provided for being fixedly connected to a first body of a foldable device. The second installation plate 203 is provided for being fixedly connected to a second body of the foldable device. A connection rod is provided on either side of the multi-shaft hinge, and the connection rod at one side is fixedly connected to the first installation plate 202, and the connection rod at other side is fixedly connected to the second installation plate 203. Multiple multi-shaft hinges 201 are provided, and the multiple multi-shaft hinges 201 are arranged at intervals. The decorative structure 100 is the decorative structure 100 according to the embodiment of the present application.

The multi-shaft hinge device according to the embodiment of the present application employs the multi-shaft hinge device according to the above embodiment, which has a complete appearance.

In the multi-shaft hinge device, since the number of the connection shafts 102 in the decorative structure 100 is configured to be same with the number of shafts of the multi-shaft hinge 201, and the axis of each of the connection shafts 102 in the decorative structure is configured to coincide with an axis of a corresponding shaft of each of the multiple multi-shaft hinges 201, the set of shafts formed by each of the multiple multi-shaft hinges 201 and the set of connection shafts of the decorative structure 100 may be configured to be a same set of shafts for reducing the number of the components. For facilitating the assembly of the multi-shaft hinge 201 and using light material (such as plastic) to fabricate the connection shafts 102 of the decorative structure 100 for reducing the weight of the entire multi-shaft hinge device, the set of shafts formed by each of the multiple multi-shaft hinges 201 and the set of connection shafts of the decorative structure 100 may be configured to be different sets of shafts. Accordingly, for allowing the axis of each of the connection shafts 102 in the decorative structure 100 to coincide with the axis of the corresponding shaft of each of the multiple multi-shaft hinges 201, each shaft of each of the multiple multi-shaft hinge 201 is inserted into a corresponding mounting hole of the located on the decorative block 101 at an end of the connection shafts 102 in the decorative structure 100. The mounting hole is a hole on the decorative block 101 for being sleeved on a corresponding connection shaft 102.

In the multi-shaft hinge device, multiple decorative structures 100 may be provided according to the number of gaps between adjacent multi-shaft hinges 201. Correspondingly, each of the multiple decorative structures 100 can be the same, different, partly same, or partly different.

The multi-shaft hinge device according to the embodiment of the present application employs the decorative structure 100 provided by the embodiment, thus it has the effects of the decorative structure 100, which will not be described here.

A foldable device is provided according to the embodiment, which includes a first body and a second body. The first body can be arranged on the second body such that the first body may be rotated about the second body in a predetermined angle range through the hinge device. The hinge device is the multi-shaft hinge device provided by the embodiment. The foldable device employs the multi-shaft hinge device provided by the embodiment, which has a complete appearance and meets the requirement of users for the appearance of the foldable device.

The above embodiments are described in a progressive manner. Each of the embodiments is mainly focused on describing its differences from other embodiments, and references can be made among these embodiments for the same or similar portions.

Based on the above description of the disclosed embodiments, the person skilled in the art is capable of carrying out or using the present application. It is obvious for the person skilled in the art to make many modifications to these embodiments. The general principle defined herein may be realized in other embodiments without departing from the spirit or scope of the present application. Therefore, the present application is not limited to the embodiments illustrated herein, but should be defined by the broadest scope consistent with the principle and novel features disclosed herein.

What is claimed is:

1. A decorative structure for a multi-shaft hinge device comprising a plurality of multi-shaft hinges rotatably connecting a first installation plate to a second installation plate, the decorative structure comprising:
a plurality of connection shafts;
a plurality of decorative blocks comprising:
at least one first decorative block sleeved on two adjacent connection shafts of the plurality of connection shafts; and
at least one second decorative block sleeved on one outmost connection shaft of the plurality of connection shafts and fixedly connected to one of the first installation plate and the second installation plate.

2. The decorative structure according to claim 1, wherein the decorative structure is located between two adjacent multi-shaft hinges in the multi-shaft hinge device, and the plurality of connection shafts are arranged in parallel.

3. The decorative structure according to claim 2, wherein, the number of the plurality of connection shafts is same with the number of shafts of each of the plurality of multi-shaft hinges.

4. The decorative structure according to claim 3, wherein, each of the plurality of connection shafts coincides with an axis of a corresponding shaft of each of the plurality of the multi-shaft hinges.

5. The decorative structure according to claim 2, wherein, the plurality of decorative blocks are arranged in the direction of the arrangement of the plurality of connection shafts and form a set of decorative blocks, and the set of decorative blocks comprise the first decorative block.

6. The decorative structure according to claim 5, wherein, a plurality of sets of decorative blocks are provided, and the first decorative blocks in adjacent sets of decorative blocks are staggered.

7. The decorative structure according to claim 6, wherein, the number of the plurality of connection shafts is an even number, the plurality of sets of decorative blocks comprise a first set of decorative blocks and a second set of decorative blocks, and the first set of decorative blocks only comprises the first decorative block, and the second set of decorative blocks comprises the first decorative block and two second decorative blocks.

8. The decorative structure according to claim 6, wherein, the number of the plurality of connection shafts is an odd number, and each of the plurality of sets of decorative blocks has a same number of the first decorative blocks, each of the plurality of sets of decorative blocks has a same number of the second decorative blocks, and each of the plurality of sets of decorative blocks has one second decorative block.

9. A multi-shaft hinge device, comprising:
a first installation plate configured to be fixedly connected to a first body of a foldable device;
a second installation plate configured to be fixedly connected to a second body of the foldable device;
at least one multi-shaft hinge, wherein a connection rod at one side of the multi-shaft hinge is fixedly connected to the first installation plate, and a connection rod at the other side of the multi-shaft hinge is fixedly connected to the second installation plate; and
a decorative structure comprising:
a plurality of connection shafts;
a plurality of decorative blocks comprising:
at least one first decorative block sleeved on two adjacent connection shafts of the plurality of connection shafts; and
at least one second decorative block sleeved on one outmost connection shaft of the plurality of connection shafts and fixedly connected to one of the first installation plate and the second installation plate.

10. The multi-shaft hinge device according to claim 9, wherein the decorative structure is located between two adjacent multi-shaft hinges in the multi-shaft hinge device, and the plurality of connection shafts are arranged in parallel.

11. The multi-shaft hinge device according to claim 10, wherein, the number of the connection shafts is same with the number of shafts of each of the plurality of multi-shaft hinges.

12. The multi-shaft hinge device according to claim 11, wherein, each of the plurality of connection shafts coincides with an axis of a corresponding shaft of each of the plurality of the multi-shaft hinges.

13. The multi-shaft hinge device according to claim 10, wherein, the plurality of decorative blocks are arranged in the direction of the arrangement of the connection shafts and form a set of decorative blocks, and the set of decorative blocks comprise the first decorative block.

14. The multi-shaft hinge device according to claim 13, wherein, a plurality of sets of decorative blocks are provided, and the first decorative blocks in two adjacent sets of decorative blocks are staggered.

15. The multi-shaft hinge device according to claim 14, wherein, the number of the connection shafts is an even number, the plurality of sets of decorative blocks comprise a first set of decorative blocks and a second set of decorative blocks, and the first set of decorative blocks only comprises the first decorative block, and the second set of decorative blocks comprises the first decorative block and two second decorative blocks.

16. The multi-shaft hinge device according to claim 14, wherein, the number of the connection shafts is an odd number, and each of the plurality of sets of decorative blocks has a same number of the first decorative blocks, each of the plurality of sets of decorative blocks has a same number of the second decorative blocks, and each of the plurality of sets of decorative blocks has one second decorative block.

17. The multi-shaft hinge device according to claim 10, wherein, each of shafts of the multi-shaft hinge is inserted into a corresponding mounting hole of the decorative block at an end of the connection shafts in the decorative structure, and the mounting hole is a hole on the decorative bock for being sleeved on corresponding connection shaft to allow the axis of the connection shaft to coincide with the axis of the shaft of the multi-shaft hinge.

18. The multi-shaft hinge device according to claim 13, wherein, each of shafts of the multi-shaft hinge is inserted into a corresponding mounting hole of the decorative block at an end of the connection shafts in the decorative structure, and the mounting hole is a hole on the decorative bock for being sleeved on a corresponding connection shaft to allow the axis of the connection shaft to coincide with the axis of the shaft of the multi-shaft hinge.

19. A foldable device, comprising a first body and a second body, wherein the first body is rotatable about the second body in a predetermined angle range through a hinge device, and the hinge device is a multi-shaft hinge device comprising a first installation plate configured to be fixedly connected to a first body of a foldable device;
a second installation plate configured to be fixedly connected to a second body of the foldable device;
at least one multi-shaft hinge, wherein a connection rod at one side of the multi-shaft hinge is fixedly connected to the first installation plate, and a connection rod at the other side of the multi-shaft hinge is fixedly connected to the second installation plate; and
a decorative structure comprising:
a plurality of connection shafts;
a plurality of decorative blocks comprising:
at least one first decorative block sleeved on two adjacent connection shafts of the plurality of connection shafts; and
at least one second decorative block sleeved on one outmost connection shaft of the plurality of connection shafts and fixedly connected to one of the first installation plate and the second installation plate.

20. The foldable device according to claim 19, wherein, each of shafts of the multi-shaft hinge is inserted into a corresponding mounting hole of the decorative block at an end of the connection shafts in the decorative structure, and the mounting hole is a hole on the decorative bock for being sleeved on a corresponding connection shaft to allow the axis of the connection shaft to coincide with the axis of the shaft of the multi-shaft hinge.
